(19) United States
(12) Patent Application Publication
(10) Pub. No.: US 2006/0061577 A1
(43) Pub. Date: Mar. 23, 2006

(54) Efficient interface and assembler for a graphics processor

(76) Inventor: Vijay Subramaniam, San Diego, CA (US)

Correspondence Address: QUALCOMM, INC, 5775 MOREHOUSE DR., SAN DIEGO, CA, 92121, US

(21) Appl. No.: 10/947,993

(22) Filed: Sep. 22, 2004

(51) Int. Cl. G06T 1/00; G06F 15/00

(52) U.S. Cl. 345/501

(57) ABSTRACT

A graphics processor and method is disclosed wherein vertex information is retrieved from an application processor, and used to assemble surfaces representing a graphic image. The assembled surfaces may then be rendered into pixel information. The vertex information comprises a plurality of data blocks with each of the data blocks having data for one vertex associated with at least one of the surfaces. Each of the data blocks has a variable length corresponding to the vertex data contained therein. In at least one embodiment of the graphics processor, the vertex information may be retrieved in batches from the application processor using a ping-pong vertex buffer configuration. In the same or alternative embodiment of the graphics processor, the pixel information may be presented to a display through a ping-pong arrangement of frame buffers controlled by instructions generated by the application processor.

### BACKGROUND

1. Field

The present disclosure relates generally to graphic imaging, and more specifically, to an efficient interface and assembler for a graphics processor.

2. Background

The integration of electronic games and multi-media presentations into personal computers, laptops, mobile phones, personal digital assistants (PDA) and other devices has become mainstream in today's consumer electronic marketplace. These electronic games and multi-media presentations are supported through technology known as three-dimensional (3D) graphics. 3D graphics is used to create graphic images, and project those images onto a two-dimensional (2D) display. This may be achieved by breaking down the graphic images into fundamental components, such as triangles, squares, rectangles, parallelograms, or other suitable surfaces. A typical graphic image might require thousands of surfaces put together into a structure called a wireframe. The surfaces of the wireframe may be further processed before being rendered into pixel information suitable for driving a display.

Traditionally, the computer's central processing unit (CPU) has been used to fully process the structures of the wireframe with hardware being used to render the surfaces into pixel information. This approach works, but the CPU must do a substantial amount of processing on the surfaces of the wireframe, as well as other processing functions such as audio and user inputs. As a result, the CPU can become overworked and unable to serve the various software requirements in real time. This problem may become even more pronounced as consumer demand increases for more realistic graphics.

What is needed therefore is a graphics processor that takes more responsibility from the CPU. The graphics processor should have an efficient interface and assembler to enhance the visual quality of the graphic image.

### SUMMARY

In one aspect of the present invention, a graphics processor includes memory configured to receive vertex information associated with a plurality of surfaces representing a graphic image, the vertex information comprising a plurality of data blocks with each of the data blocks having data for one vertex associated with at least one of the surfaces, and wherein each of the data blocks has a variable length corresponding to the vertex data contained therein. The graphics processor also includes an assembler configured to assemble the surfaces from the vertex information in the memory, and a pixel processing engine configured to render the surfaces assembled by the assembler into pixel information.

In another aspect of the present invention, a method of graphic imaging includes retrieving vertex information from an application processor, the vertex information being associated with a plurality of surfaces representing a graphic image, the vertex information comprising a plurality of data blocks with each of the data blocks having data for one vertex associated with at least one of the surfaces, and wherein each of the data blocks has a variable length corresponding to the vertex data contained therein. The method also includes assembling the surfaces from the retrieved vertex information, and rendering the assembled surfaces into pixel information.

In yet another aspect of the present invention, a graphics processor includes means for retrieving vertex information from an application processor, the vertex information being associated with a plurality of surfaces representing a graphic image, the vertex information comprising a plurality of data blocks with each of the data blocks having data for one vertex associated with at least one of the surfaces, and wherein each of the data blocks has a variable length corresponding to the vertex data contained therein. The graphics processor also includes means for assembling the surfaces from the retrieved vertex information, and means for rendering the assembled surfaces into pixel information.

In still another aspect of the present invention, a method of graphic imaging includes retrieving vertex information from an application processor, the vertex information being associated with a plurality of surfaces representing a graphic image, and wherein the vertex information is retrieved from the application processor in batches, each of the batches of the vertex information being associated with more than one of the surfaces. The method also includes assembling the surfaces from the retrieved vertex information, and rendering the assembled surfaces into pixel information.

In a further aspect of the present invention, a graphics processor includes memory configured to receive vertex information associated with a plurality of surfaces representing a graphic image and a plurality of instruction with the vertex information, an assembler configured to assemble the surfaces from the vertex information in the memory, and a pixel processing engine comprising ping-pong frame buffers, and wherein the pixel processing engine, in response to the instructions in the memory, is further configured to provide pixel information generated from a first portion of the assembled surfaces to a display from one of the ping-pong frame buffers, and at the same time, write pixel information generated from a second portion of the assembled surfaces to the other one of the ping-pong frame buffers.

In yet a further aspect of the present invention, a graphics imaging system includes an application processor configured to generate a graphic image comprising a plurality of surfaces defined by vertex information, the application processor comprising ping-pong buffers, and further being configured to write a first batch of the vertex information to one of the ping-pong buffers. The graphics imaging system also includes a graphics processor having an interface configured to retrieve a second batch of the vertex information from the other one of the ping-pong buffers at the same time the application processor writes the first batch of the vertex information to said one of the ping-pong buffers, the graphics processor further comprising a pixel processing engine configured to render surfaces assembled from the second batch of the vertex information into pixel information.

It is understood that other embodiments of the present invention will become readily apparent to those skilled in the art from the following detailed description, wherein various embodiments of the invention are shown and described by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Aspects of the present invention are illustrated by way of example, and not by way of limitation, in the accompanying drawings, wherein:

FIG. 1 is a conceptual block diagram of a 3D graphics system illustrating the operation of an application processor;

FIG. 2 is a conceptual block diagram of a 3D graphics system illustrating the operation of a graphics processor;

FIG. 3 is a conceptual block diagram of a 3D graphics system illustrating the interface between an application processor and a graphics processor;

FIG. 4A is a conceptual diagram illustrating the manner in which instructions and vertex information are retrieved from an application processor and stored in memory in a graphics processor;

FIG. 4B is a conceptual diagram illustrating the data structure of the vertex information in memory of the graphics processor of FIG. 4A;

FIG. 5A is a pictorial representation of a triangle strip; and

FIG. 5B is a pictorial representation of a triangle fan.

### DETAILED DESCRIPTION

The detailed description set forth below in connection with the appended drawings is intended as a description of various embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention.

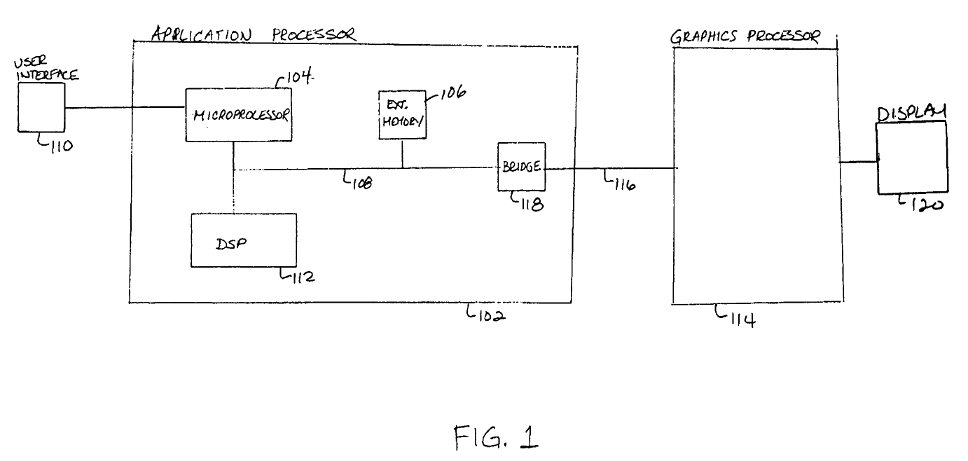

FIG. 1 is a conceptual block diagram illustrating a 3D graphics system integrated into a personal computer, laptop, mobile phone, PDA, or other suitable device. The 3D graphics system may include an application processor 102. The purpose of the application processor 102 is to generate wireframe structures of 3D graphic images and convert those images into wireframe structures.

The application processor 102 may be any software implemented entity. In the embodiment of the 3D graphics system shown in FIG. 1, the application processor 102 includes a microprocessor 104 with external memory 106. A system bus 108 may be used to support communications between the two. The microprocessor 104 may be used to provide a platform to run various software programs, such as 3D graphics software for electronic games. The software may be programmed into external memory 106 at the factory, or alternatively, downloaded during operation from a remote server through a wireless link, a telephone line connection, a cable modem connection, a digital subscriber line (DSL), a fiber optic link, a satellite link, or any other suitable communications link.

In electronic game applications, the software may be used to create a virtual 3D world to represent the physical environment in which the game will be played. A user may be able to explore this virtual 3D world by manipulating a user interface 110. The user interface 110 may be a keypad, a joystick, a trackball, a mouse, or any other suitable device that allows the user to maneuver through the virtual 3D world—move forward or backward, up or down, left or right. The software may be used to produce a series of 3D graphic images that represent what the user might see as he or she maneuvers through this virtual 3D world.

The application processor 102 may also include a DSP 112 connected to the system bus 108. The DSP 112 may be implemented with an embedded graphics software layer which runs application specific algorithms to reduce the processing demands on the microprocessor 104. The DSP 112 may be used to break up each of the 3D graphic images into surfaces to create a wireframe structure. To illustrate the operation of the 3D graphics system, triangular surfaces will be used in the following description. However, those skilled in the art may be readily able to extend the principles described herein to other surfaces such as squares, rectangles, parallelograms, or other suitable surfaces.

The DSP 112 may also perform other processing functions including, by way of example, applying an exterior surface to the wireframe structure. The DSP 112 may also apply various lighting models to the exterior surface elements. Back face culling may be used to remove the portions of the wireframe, and particularly the back side of the wireframe, that would not be seen by a user. The wireframe structure may also be clipped to remove those portions of the image outside the display.

The wireframe structure, with its exterior surface elements, may then be transformed by the DSP 112 from 3D mathematical space to 2D display space. In 2D display space, each triangle may be defined by the display coordinates and surface attributes of its three vertices. The surface attributes may include depth (Z), color (R,G,B), specular color (R_{S}, G_{S}, B_{S}), texture (U, V), and blending information (A). Blending information relates to transparency and specifies how the pixel's colors should be merged with another pixel when the two are overlaid, one on top of the other. The display coordinates and surface attributes for each surface will be referred to herein as “vertex information.” The vertex information generated by the DSP 112 may be stored in the external memory 106, or alternatively, in the DSP's internal memory.

The vertex information may also include the area of each triangle. The DSP 112 may compute the area of a triangle by taking the cross product of any two vectors in the triangle. This area will have a positive sign for a triangle with a counter-clockwise vertex order, and a negative sign otherwise. The sign of the area may be used to render the triangle into pixel information in a manner to be described in greater detail later.

A graphics processor 114 may communicate with the application processor 102 over an external bus 116. A bridge 118 may be used to transfer data between the external bus 116 and the system bus 108. The purpose of the graphics processor 114 is to reduce the load on the application processor 102. In one embodiment, the graphics processor 114 is designed with specialized hardware components so that it can perform its processing functions very quickly.

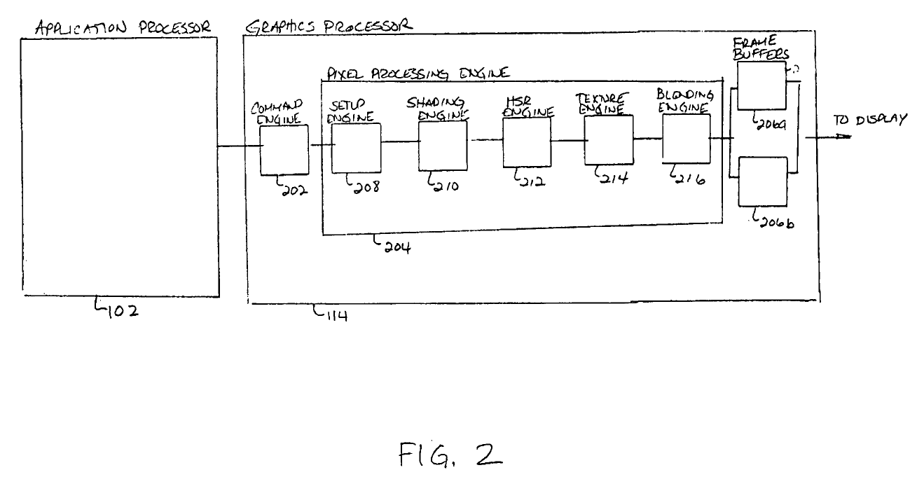

FIG. 2 is a conceptual block diagram of a graphics processor. The graphics processor 114 may include a command engine 202, a pixel processing engine 204, and frame buffers 206a and 206b. The command engine 202 may be used to assemble triangles from the vertex information generated by the application processor 102 and provide the triangles to the pixel processing engine 204. In a manner to be described in greater detail later, the triangles may be assembled by the command engine 202 based on a first set of instructions it receives from the application processor 102. The pixel processing engine 204 may be used to render each triangle into pixel information. The frame buffers 206a and 206b may be arranged in a ping-pong configuration so that the pixel processing engine 204 may write to one of the frame buffers while the command engine 202 releases pixel information from the other frame buffer for presentation to a display 120 (see FIG. 1). The command engine 202 may be used to control the ping-pong operation of the frame buffers 206a and 206b from a second set of instructions it receives from the application processor 102.

A pixel processing engine 204 may be used to render each triangle into pixel information using an interpolation process to fill the interior of the triangle based on the location of the pixels within the triangle and the attributes defined at the three vertices. Every attribute of a vertex may be represented by a linear equation as a function of the display coordinates (x,y) as follows:
K(x,y)=Aₖx+Bₖy+Cₖ (1)
where k=Z, A, R, G, B, R_{S}, G_{S}, B_{S}, U, V.

The interior of the triangle may be defined by edge equations. A triangle's three edges may be represented by linear equations as a function of the display coordinates (x,y) as follows:
E₀(x,y)=A₀x+B₀y+C₀ (2)
E₁(x,y)=A₁x+B₁y+C₁ (3)
E₂(x,y)=A₂x+B₂y+C₂ (4)

In at least one embodiment of the graphics processor 114, the command engine 202 provides one triangle at a time to the pixel processing engine 204. In particular, the command engine 202 provides to a setup engine 208 a triangle consisting of the triangle's area, as well as the display coordinates and attributes for the triangle's three vertices. The setup engine 208 may use this information to compute the attribute coefficients (Aₖ, Bₖ, Cₖ), and the edge coefficients (A₀₋₂, B₀₋₂, C₀₋₂). To avoid unnecessary processing delays, the command engine 202 may be configured to provide a new triangle to the setup engine 208 immediately after the setup engine 208 finishes computing the attribute and edge coefficients for the current triangle.

The setup engine 208 may be configured to provide the attribute and edge coefficients, along with the triangle from which the coefficients were computed, to a shading engine 210. The shading engine 210 may be used to perform linear interpolation for each pixel within the triangle. This may be done in variety of fashions. By way of example, the shading engine 210 may create a bounding box around the triangle, and then step through the bounding box pixel-by-pixel in a raster scan fashion. For each pixel, the shading engine 210 determines whether the pixel is in the triangle using the edge equations set forth in equations (2)-(4) above. The pixel is considered inside the triangle if E₀(x,y), E₁(x,y), and E₂(x,y) are all greater than or equal to zero. This relationship assumes that the triangle is provided to the pixel processing engine 204 in a counter-clockwise vertex order. This may be accomplished in software by the application processor 102, or alternatively in the command engine 202. If the command engine 202 is responsible for ensuring the proper vertex order of the triangles, it may do this by evaluating the sign bit of the triangle's area. As discussed earlier, the area of the triangle computed by the application processor 102 will have a positive sign for a triangle with a counter-clockwise vertex order, and a negative sign otherwise. Thus, the command engine 202 may reverse the order in which the vertices are provided to the pixel processing engine 204 if the sign bit is negative. In any event, if the shading engine 210 determines that the pixel is not in the triangle, then the shading engine goes to the next pixel. If, however, the shading engine 210 determines that the pixel is in the triangle, then the shading engine 210 may compute the pixel's attributes from equation (1).

A HSR (Hidden Surface Removal) engine 212 may be used to remove hidden pixels when one object is in front of another object. This may be achieved by comparing the depth attribute of a new pixel against the depth attribute of a previously rendered pixel having the same display coordinates and drop pixels that are not visible.

The attributes of each visible pixel from the HSR engine 212 may be provided to a texture engine 214. The texture engine 214 may use the texture attributes of the pixel to retrieve texture data from memory (not shown). The texture data along with the attributes of the pixel may be provide to a blending engine 216 which blends the pixel with the texture data. The pixel may be further blended with any previously rendered pixel having the same display coordinates to create a transparency effect. The results may be stored in the frame buffers 206a and 206b.

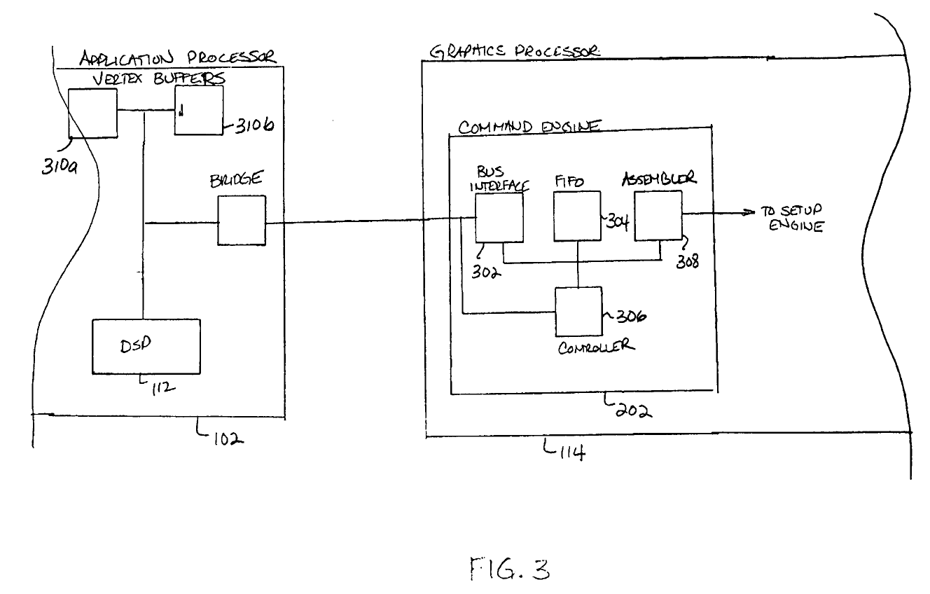

FIG. 3 is a conceptual block diagram of the command engine. The memory in the application processor 102 may be configured with vertex buffers 310a and 310b arranged in a ping-pong configuration so that the DSP 112 can write to one of the vertex buffers while the command engine 202 reads from the other vertex buffer. The ping-pong configuration enables the command engine 202 to retrieve vertex information in batches rather than a triangle at a time. Single triangle requests by the command engine 202 increases the number of interrupts to the application processor 102, which may slow it down and result in poor performance.

The command engine 202 may include a bus interface 302 and a data queue. The data queue may be any type of storage device including, by way of example, a first-in-first-out (FIFO) memory 304. The command engine 202 may also include a controller 306 which may be used to request access to the vertex buffers 310a and 310b in the application processor 102 to fill the FIFO 304 with instructions and vertex information. The controller 306 may use sideband signaling to send an interrupt to the DSP 112 to access the vertex buffers 310a and 310b. In response to the interrupt, the DSP 112 may grant access to one of the vertex buffers by sending the start and stop addresses for the batch of vertex information to be retrieved. If the DSP 112 is writing to one of the buffers when it receives an interrupt from the controller 306, it will allow the command engine 202 to read instructions and vertex information from the other vertex buffer. When the DSP 112 finishes writing to the vertex buffer, the buffer may be locked by the DSP 112 until the DSP 112 receives another interrupt from the controller 306. The command engine 202 reads the vertex buffer completely before sending an interrupt to the DSP 112 for more vertex information.

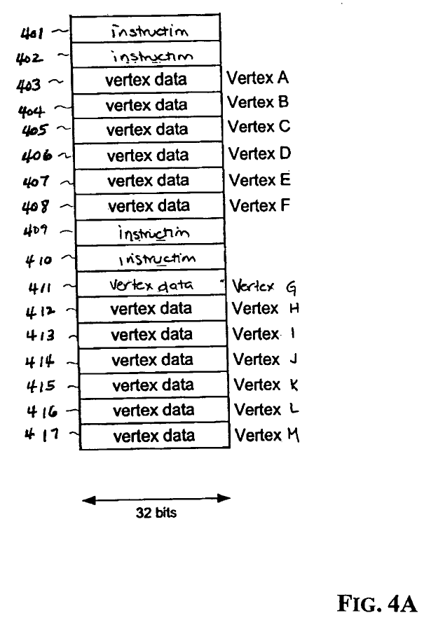

The instructions and vertex information may be placed in the FIFO memory as shown in FIG. 4A. The FIFO memory includes a number of memory blocks with the instructions and vertex information being shifted in from the bottom of the FIFO memory and shifted out through the top. The FIFO memory is shown with instructions occupying the first two memory blocks 401 and 402, followed by vertex information for six vertices with the vertex information for each vertex occupying one memory block 403-408. Two more instructions occupying the next two memory blocks 409 and 410 are shown followed by vertex information for seven more vertices, again with the vertex information for each vertex occupying one memory block 411-417.

FIG. 4B shows an example of the data structure for the vertex information in each memory block. In this example, the memory block is 6×32-bits. The first address A₁ may be used to store 32-bits of data indicating the area of the triangle to which the vertex belongs. The second address A₂ may be used to store the display coordinates for the vertex. The display coordinates includes a 16-bit x-coordinate and a 16-bit y-coordinate. The attributes of the vertex may be stored at the last four addresses A₃-A₆. By way of example, the depth of the vertex, or the z-coordinate, may be stored at the third address A₃. An 8-bit red (R) color component and an 8-bit green (G) color component for the vertex may also be stored at the third address A₃. An 8-bit blue (B) color component for the vertex may be stored at the fourth address A₄ along with three 8-bit reflectivity components (R_{S}, G_{S}, and B_{S}). An 8-bit blending value (A) may be stored at the fifth address A₅ along with a 16-bit U texture coordinate. Finally, a 16-bit V texture coordinate may be stored at the sixth address A₆.

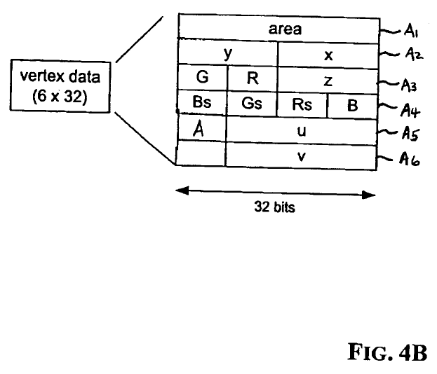

As one can readily see from FIG. 4A, the traffic on the external bus 116 between the application processor 102 and the command engine can be reduced by reducing the number of vertices required to render triangles into pixel information. This may be achieved by arranging the triangles into triangle strips or fans with multiple triangles sharing common vertices. An example of a triangle strip is shown in FIG. 5A, and an example of a triangle fan is shown in FIG. 5B. Referring to FIG. 5A, four triangles, which would ordinarily require twelve vertices, may be represented as a triangle strip with six vertices. Referring to FIG. 5B, five triangles, which would ordinarily require fifteen vertices, may be represented as a triangle fan with seven vertices.

Referring to FIGS. 3, 4A, 5A and 5B, an assembler 308 may be used to interpret the instructions and assemble triangles. Alternatively, the controller 306 may be used to interpret the instructions and configure the assembler 308 to assemble the triangles. The manner in which the triangles are assembled from the strips and fans may vary depending on the system requirements and the overall design constraints. In one embodiment of the 3D graphics system, the assembly of the triangles may be based on the sequence in which the vertex information is received. In this embodiment, the two instructions preceding the vertex information may be used to identify the vertex information that follows as a strip or fan, and indicate which one of the frame buffers the resulting pixel information should be written to.

The assembler 308 may define the first triangle 502 of the strip by the first three vertices V_{A}, V_{B}, V_{C} it receives from the FIFO memory 304. The area for the first triangle 502 may be included with the vertex information for any of the three vertices. The second triangle 504 in the strip may be defined by the assembler 308 from the next vertex V_{D} it receives and the two vertices V_{B}, V_{C} last received. The area for the second triangle 504 may be included in the vertex information for the vertex V_{D}. Referring to FIG. 5A, one can readily see that the vertices for the first triangle 502 are provided to the assembler 308 in a counter-clockwise order 503, but the vertices for the second triangle 504 are provided to the assembler in a clockwise order 505. Accordingly, the assembler 308 may be used to reverse the order of the last two vertices V_{C}, V_{D} before providing the second triangle 504 to the pixel processing engine.

The remaining triangles in the strip may be defined in a similar fashion with the third triangle 506 being defined by the vertices V_{C}, V_{D}, V_{E}, and the fourth triangle 508 being defined by the vertices V_{D}, V_{E}, V_{F}. The area for the third triangle 506 may be included in the vertex information for the vertex V_{E}, and the area for the fourth triangle 508 may be included in the vertex information for the vertex V_{F}. The assembler 308 may be used to reverse the order of the last two vertices V_{E}, V_{F} so that the fourth triangle 508 can be presented to the pixel processing engine with a counter-clockwise vertex order.

The triangles of the fan may be constructed in a similar way. The assembler 308 may define the first triangle 510 in the fan by the first three vertices V_{G}, V_{H}, V_{I} it receives from the FIFO memory 304, with the area of the first triangle 510 being included in the vertex information for any of the vertices. However, in the fan arrangement, the first vertex received is the common vertex for all triangles. Thus, the second triangle 512 in the fan may be defined by the assembler 308 by the common vertex V_{G}, the next vertex V_{J} it receives, and the last vertex V_{I} it received. The area of the second triangle 512 may be included in the vertex information for the vertex V_{J}. The third triangle 514 in the fan may be defined in a similar fashion from the common vertex V_{G}, the next vertex it receives V_{K}, and the last vertex it received V_{J}. The area of the third triangle 514 may be included in the vertex information for the vertex V_{K}. In this manner, the assembler 308 may define the fourth triangle 516 in the fan by vertices V_{G}, V_{K}, V_{L}, and the fifth triangle 518 in the fan by vertices V_{G}, V_{L}, V_{M}. The area of the fourth triangle 516 may be included in the vertex information for the vertex V_{G}, and the area of the fifth triangle 518 may be included in the vertex information for vertex V_{M}. The assembler 308 may be used to reverse the order of the last two vertices for each triangle in the fan so that each triangle can be presented to the pixel processing engine with a counter-clockwise vertex order.

Returning to FIG. 2, the command engine 202 may be called upon to support the processing of 100,000 or more triangles per second. The ability of the command engine 202 to meet this demand may depend largely on the amount of information that can be transmitted from the application processor 102 to the graphics processor 114. The use of a compression algorithm to pack triangles in strip or fan form can significantly reduce the bus bandwidth required to meet this demand. However, other techniques may also be employed to further increase the efficiency of data transfer between the application processor 102 and the graphics processor 114. By way of example, a variable length data structure may be used for each vertex. The length of the vertex data structure may be varied in accordance with the attributes required during the rendering process. By way of example, the surface of any number of triangles may not require texture, and therefore, the texture coordinates may be omitted from the memory block of FIG. 4B. In that case, the block of memory needed to store the vertex data may be reduced from a 6×32-bit memory block to a 5×32-bit memory block and the amount of information that needs to be transferred for the vertex is reduced from 23 bytes to 17 bytes. Since the area of the triangle does not need to be transmitted with the vertex information for two of the three vertices in the first triangle of either the strip or the fan, the memory block for these triangles can also be reduced to a 5×32-bit memory block.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC. The ASIC may reside in the sending and/or receiving component, or elsewhere. In the alternative, the processor and the storage medium may reside as discrete components in the sending and/or receiving component, or elsewhere.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A graphics processor, comprising:
memory configured to receive vertex information associated with a plurality of surfaces representing a 3D graphic image, the vertex information comprising a plurality of data blocks with each of the data blocks having data for one vertex associated with at least one of the surfaces, and wherein each of the data blocks has a variable length corresponding to the vertex data contained therein;
an assembler configured to assemble the surfaces from the vertex information in the memory; and
a pixel processing engine configured to render the surfaces assembled by the assembler into pixel information.

2. The graphics processor of claim 1 wherein the assembler is further configured to provide all the assembled surfaces to the pixel processing engine with either clockwise or counter-clockwise vertex order.

3. The graphics processor of claim 1 wherein each of the surfaces comprises a triangle.

4. The graphics processor of claim 3 wherein the vertex information is compressed into a plurality of triangle strips, a plurality of triangle fans, or a combination of both.

5. The graphics processor of claim 4 wherein the memory is further configured to receive a plurality of instructions with the vertex information, at least one of the instructions indicating whether a portion of the vertex information is formatted as a triangle strip or a triangle fan, and wherein the assembler is further configured to assemble the surfaces associated with said portion of the vertex information from said at least one of the instructions.

6. The graphics process of claim 1 wherein the data for each of the vertices includes display coordinates and attribute information, and wherein the length of the data block for each of the vertices corresponds to the amount of the attribute information contained therein.

7. The graphics processor of claim 6 wherein the attribute information includes depth, color, transparency, specular color, texture, or blending information.

8. The graphics processor of claim 1 wherein the memory is further configured to receive a plurality of instructions with the vertex information, and wherein the pixel processing engine comprises ping-pong frame buffers, and wherein the pixel processing engine, in response to the instructions in the memory, is further configured to provide the pixel information generated from a first portion of the surfaces assembled by the assembler to a display from the one of the ping-pong frame buffers, and at the same time, write the pixel information generated from a second portion of the surfaces assembled by the assembler to the other one of the ping-pong frame buffers.

9. The graphics processor of claim 1 further comprising an interface configured to retrieve a batch of the vertex information from an application processor and provide the batch to the memory, the batch of vertex information being associated with more than one of the surfaces.

10. The graphics processor of claim 9 wherein the interface is further configured to retrieve a batch of the vertex information from the application processor by sending a request to the application processor for the batch, receiving from the application processor information relating to a buffer location within the application processor for the batch, and retrieving the batch from the buffer location.

11. A method of graphic imaging, comprising:
retrieving vertex information from an application processor, the vertex information being associated with a plurality of surfaces representing a graphic image, the vertex information comprising a plurality of data blocks with each of the data blocks having data for one vertex associated with at least one of the surfaces, and wherein each of the data blocks has a variable length corresponding to the vertex data contained therein;
assembling the surfaces from the retrieved vertex information; and
rendering the assembled surfaces into pixel information.

12. The method of claim 1 wherein all the surfaces are assembled in either a clockwise or counter-clockwise vertex order.

13. The method of claim 11 wherein each of the surfaces comprises a triangle.

14. The method of claim 13 wherein the vertex information is compressed into a plurality of triangle strips, a plurality of triangle fans, or a combination of both.

15. The method of claim 14 further comprising retrieving a plurality of instructions with the vertex information from the application processor, at least one of the instructions indicating whether a portion of the vertex information is formatted as a triangle strip or a triangle fan, and wherein the surfaces associated with said portion of the vertex information are assembled from said at least one of the instructions.

16. The method of claim 11 wherein the data for each of the vertices includes display coordinates and attribute information, and wherein the length of the data block for each of the vertices corresponds to the amount of the attribute information contained therein.

17. The method of claim 16 wherein the attribute information includes depth, color, transparency, specular color, texture, or blending information.

18. The method of claim 11 further comprising receiving a plurality of instructions with the vertex information from the application processor, and in response to the instructions, providing the pixel information generated from a first portion of the assembled surfaces to a display from a first ping-pong frame buffer, and at the same time, writing the pixel information generated from a second portion of the assembled surfaces to a second ping-pong frame buffer.

19. The method of claim 11 wherein the vertex information is retrieved from the application processor in batches, each of the batches of the vertex information being associated with more than one of the surfaces.

20. The method of claim 19 wherein each of the batches is retrieved from the application processor by sending a request to the application processor for the batch, receiving from the application processor information relating to a buffer location within the application processor for the batch, and retrieving the batch from the buffer location.

21. The method of claim 11 wherein the application processor comprises ping-pong buffers, the method further comprising using the application processor to write a first batch of the vertex information to one of the ping-pong buffers, retrieve from the application processor a second batch of the vertex information from the other one of the ping-pong buffers at the same time the application processor writes the first batch of the vertex information to said one of the ping-pong buffers.

22. A graphics processor, comprising:
means for retrieving vertex information from an application processor, the vertex information being associated with a plurality of surfaces representing a graphic image, the vertex information comprising a plurality of data blocks with each of the data blocks having data for one vertex associated with at least one of the surfaces, and wherein each of the data blocks has a variable length corresponding to the vertex data contained therein;
means for assembling the surfaces from the retrieved vertex information; and
means for rendering the assembled surfaces into pixel information.

23. A graphics processor, comprising:
memory configured to store vertex information associated with a plurality of surfaces representing a graphic image, and a plurality of instructions with the vertex information;
an interface configured to retrieve a batch of the vertex information from an application processor and provide the batch to the memory, the batch of vertex information being associated with more than one of the surfaces;
an assembler configured to assemble the surfaces from the vertex information in the memory; and
a pixel processing engine configured to render the assembled surfaces into pixel information.

24. The graphics processor of claim 23 wherein the interface is further configured to retrieve a batch of the vertex information from the application processor by sending a request to the application processor for the batch, receiving from the application processor information relating to a buffer location within the application processor for the batch, and retrieving the batch from the buffer location.

25. The graphics processor of claim 23 wherein the vertex information comprising a plurality of data blocks with each of the data blocks having data for one vertex associated with at least one of the surfaces, and wherein each of the data blocks has a variable length corresponding to the vertex data contained therein.

26. The graphics process of claim 25 wherein the data for each of the vertices includes display coordinates and attribute information, and wherein the length of the data block for each of the vertices corresponds to the amount of the attribute information contained therein.

27. The graphics processor of claim 26 wherein the attribute information includes depth, color, transparency, specular color, texture, or blending information.

28. The graphics processor of claim 23 wherein each of the surfaces comprises a triangle.

29. The graphics processor of claim 28 wherein the vertex information is compressed into a plurality of triangle strips, a plurality of triangle fans, or a combination of both.

30. The graphics processor of claim 29 wherein the memory is further configured to receive a second plurality of instructions with the vertex information, at least one of the second plurality of instructions indicating whether a portion of the vertex information is formatted as a triangle strip or a triangle fan, and wherein the assembler is further configured to assemble the triangles associated with said portion of the vertex information from said at least one of the second plurality of instructions.

31. The graphics processor of claim 23 wherein the assembler is further configured to provide all the assembled surfaces to the pixel processing engine with either clockwise or counter-clockwise vertex order.

32. A method of graphic imaging, comprising:
retrieving vertex information from an application processor, the vertex information being associated with a plurality of surfaces representing a graphic image, and wherein the vertex information is retrieved from the application processor in batches, each of the batches of the vertex information being associated with more than one of the surfaces;
assembling the surfaces from the retrieved vertex information; and
rendering the assembled surfaces into pixel information.

33. The method of claim 32 wherein each of the batches is retrieved from the application processor by sending a request to the application processor for the batch, receiving from the application processor information relating to a buffer location within the application processor for the batch, and retrieving the batch from the buffer location.

34. The method of claim 32 wherein the vertex information comprises a plurality of data blocks with each of the data blocks having data for one vertex associated with at least one of the surfaces, and wherein each of the data blocks has a variable length corresponding to the vertex data contained therein

35. The method of claim 34 wherein the data for each of the vertices includes display coordinates and attribute information, and wherein the length of the data block for each of the vertices corresponds to the amount of the attribute information contained therein.

36. The method of claim 35 wherein the attribute information includes depth, color, transparency, specular color, texture, or blending information.

37. The method of claim 32 wherein each of the surfaces comprises a triangle.

38. The method of claim 37 wherein the vertex information is compressed into a plurality of triangle strips, a plurality of triangle fans, or a combination of both.

39. The method of claim 38 further comprising retrieving a second plurality of instructions with the vertex information from the application processor, at least one of the second plurality of instructions indicating whether a portion of the vertex information is formatted as a triangle strip or a triangle fan, and wherein the triangles associated with said portion of the vertex information are assembled from said at least one of the second plurality of instructions.

40. The method of claim 32 wherein all the surfaces are assembled in either a clockwise or counter-clockwise vertex order.

41. A graphics processor, comprising:
memory configured to receive vertex information associated with a plurality of surfaces representing a graphic image and a plurality of instruction with the vertex information;
an assembler configured to assemble the surfaces from the vertex information in the memory; and
a pixel processing engine comprising ping-pong frame buffers, and wherein the pixel processing engine, in response to the instructions in the memory, is further configured to provide pixel information generated from a first portion of the assembled surfaces to a display from one of the ping-pong frame buffers, and at the same time, write pixel information generated from a second portion of the assembled surfaces to the other one of the ping-pong frame buffers.

42. A graphics imaging system, comprising:
an application processor configured to generate a graphic image comprising a plurality of surfaces defined by vertex information, the application processor comprising ping-pong buffers, and further being configured to write a first batch of the vertex information to one of the ping-pong buffers; and
a graphics processor having an interface configured to retrieve a second batch of the vertex information from the other one of the ping-pong buffers at the same time the application processor writes the first batch of the vertex information to said one of the ping-pong buffers, the graphics processor further comprising a pixel processing engine configured to render surfaces assembled from the second batch of the vertex information into pixel information.

43. The computer graphic imaging system of claim 42 further comprising a display coupled to the graphics processor.
